(19) United States
(12) Patent Application Publication
(10) Pub. No.: US 2010/0332307 A1
(43) Pub. Date: Dec. 30, 2010

(54) REBATE PROGRAMS ADMINISTERED VIA PAYMENT PROCESSING SYSTEM BASED ON MERCHANT-AGGREGATED DATA

(76) Inventor: Stephen A. Parento, White Plains, NY (US)

Correspondence Address: BUCKLEY, MASCHOFF & TALWALKAR LLC, 50 LOCUST AVENUE, NEW CANAAN, CT, 06840, US

(21) Appl. No.: 12/491,423

(22) Filed: Jun. 25, 2009

(51) Int. Cl. G06Q 30/00; G06Q 10/00; G06Q 20/00

(52) U.S. Cl. 705/14.34

(57) ABSTRACT

A method includes receiving a batch of transaction data. The transaction data is transmitted from a computer operated by or on behalf of a merchant. The transaction data relates to a plurality of purchase transactions performed at the merchant. The transaction data includes purchased item data that identifies at least some items purchased in the purchase transactions. The transaction data includes for each purchase transaction a respective payment card account number that identifies a respective payment card account to which the purchase transaction in question was charged. The method further includes identifying, from the transaction data, ones of the purchase transactions that qualify for customer rebates.

### BACKGROUND

Embodiments disclosed herein relate to payment systems. In particular, some embodiments relate to methods, apparatus, systems, means and computer program products for administering a payment processing network.

Many merchants have established so-called “loyalty programs” to induce customers to increase the proportion of purchases made at the merchant in question. Another aspect of many loyalty programs involves accumulation by the merchant of information about what products customers purchase, as well as where and when these purchases occur. The information collected in this way may aid merchants in formulating their marketing and merchandising strategies. Some loyalty programs provide rebate coupons that are redeemable in connection with purchases at the sponsoring merchant. Other loyalty programs involve granting of “rewards points” to customers, who may redeem the points for bonus merchandise items, etc.

Other known techniques for influencing buying behavior involve paper or electronic coupons that customers may redeem for discounts on particular items, or on aggregate purchases at a particular merchant. According to still other techniques, product manufacturers and distributors may offer mail-in or web-based rebate programs. In these programs, customers who purchase certain items present proof of purchase and thereafter receive a partial reimbursement for the purchase price.

Many, if not all, of these programs and techniques suffer from disadvantages. For example, paper coupons are well known to be very inefficient, in that only a small proportion of issued coupons are actually redeemed and there are significant costs associated with printing and processing redemptions. Rewards points, on the other hand, may not be attractive to consumers who do not wish to take time to keep track of their points accounts, or are not interested in the items for which the points are redeemable. Similarly, mail-in and web-based rebate programs may be unattractive to consumers who may find it to be inconvenient to mail in or enter proof of purchase or later to cash or deposit the resulting rebate check. Moreover, some consumers may not wish to carry and present the loyalty program cards issued in connection with some merchants' programs.

A pending U.S. patent application which has been published as publication no. 2008/0255940, and which is commonly assigned herewith, discloses a system in which customer rebates—based on particular items that are purchased—may be implemented utilizing the infrastructure of a conventional payment card system. (The disclosure of the '940 published application is incorporated herein by reference.) While the system of the '940 published application is advantageous in many ways, the present inventor has conceived, and discloses herein, an alternative system that offers additional or alternative advantages while also utilizing the infrastructure of a conventional payment card system to implement item-level-based customer rebates.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram of a system provided in accordance with the present invention for implementing customer rewards or rebate programs.

FIG. 2 is a simplified block diagram of a rebate computer that is part of the system of FIG. 1.

FIG. 3 is a flow chart that illustrates a process performed in accordance with aspects of the present invention in the rebate computer of FIG. 2.

FIG. 4 is a flow chart that illustrates aspects of a rebate program process from the point of view of a customer/cardholder.

FIG. 5 is a flow chart that illustrates aspects of a rebate program process from the point of view of a merchant/retailer.

### DETAILED DESCRIPTION

In general, and for the purpose of introducing concepts of embodiments of the present invention, one or more rebate programs funded by product manufacturers/distributors or other entities are implemented via a payment processing network such as that administered by MasterCard International Inc., the assignee hereof. A participating retailer stores transaction data that represents payment card transactions performed at the retailer's store locations. The transaction data includes the date of the transaction, the store location, and the payment card account number for the account to which the transaction was charged. The transaction data also includes product item level data that indicates individual items purchased in the transactions. On a regular basis (e.g., daily or weekly) the retailer uploads the transaction data to a rebate computer that may be associated with the payment processing network. The rebate computer stores information that defines one or more rebate programs. The rebate program information indicates what item purchases qualify for rebates, and the amounts of the rebates. The rebate computer screens the transaction data received from the retailer and identifies item purchases that qualify for rebates. To implement the rebates, the rebate computer (or another entity that receives rebate information from the rebate computer) initiates payment transactions in the payment processing network to cause rebates to be credited to cardholder accounts for the customers who made the qualifying item purchases. The rebate computer or entity that initiates the payment transactions may collect the funding for the rebates from the product manufacturers/distributors (and/or merchants) who sponsor the rebate programs.

In some embodiments, all of the transaction data stored by a retailer and uploaded by the retailer to the rebate computer may relate to transactions performed using a payment card that is co-branded by the retailer. In some embodiments, the retailer-co-branded payment cards may be prepaid payment cards.

These systems and methods allow for rebates funded by product manufacturers/distributors to be automatically and conveniently credited to payment card accounts of customers who purchase qualifying products. Processing and administrative economies are realized by using a previously existing payment processing network as the vehicle for payment rebates. Little or no modification of the payment processing network itself is required. A rebate process of this type may also supplement retailers' customer loyalty programs, and does not require modification or programming of point of sale terminals. The systems and methods described herein also may facilitate great flexibility in designing rebate programs.

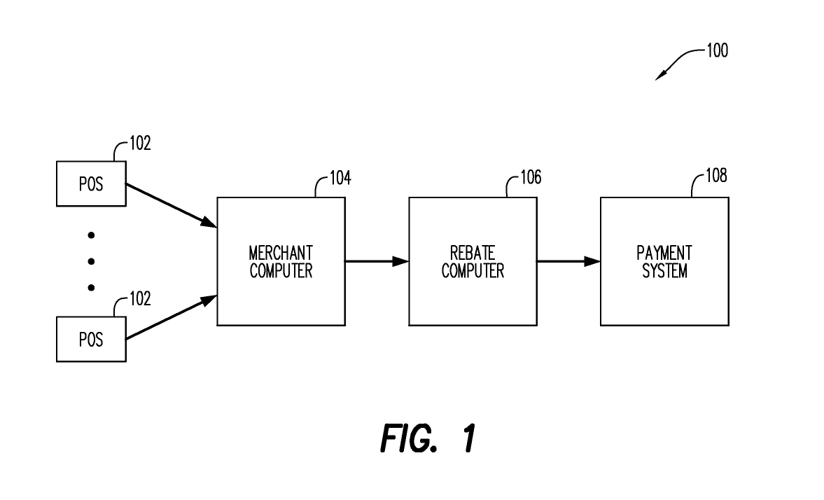

FIG. 1 is a block diagram of a system 100 provided in accordance with the present invention for implementing customer rewards or rebate programs.

The system 100 includes numerous POS locations 102 at which point of sale terminals are located. In the particular illustration of the system 100 as presented in FIG. 1, all of the POS locations 102 are at stores operated by a particular retailer. However, in certain practical embodiments of the invention, two or more, and even a considerable number, of retailers may participate in the system 100. The term “POS location” refers to “points of transaction” such as physical point of sale terminals located in brick-and-mortar retail stores, internet commerce sites that receive payment account numbers from customers who shop online, and mail order or telephone (MOTO) merchants who receive payment account numbers by telephone and/or mail. In one preferred embodiment of the invention each retailer may be a major chain of brick-and-mortar retail stores, and may issue (with a cooperating financial institution) a co-branded payment card that carries the retailer's logo. For example, the retailers may be major grocery, pharmacy or discount department store chains.

In some embodiments, or in the case of some cards, the co-branded payment card may be a pre-paid payment card that is accessible even to “unbanked” customers of the retailer. In the case of physical point of sale terminals, a payment card (not shown; may be, e.g., a credit or debit card, a charge card or stored value card, or a corporate or so-called fleet card—or a pre-paid card, as discussed above) is presented to the terminal by a customer and read by the terminal to input the number of the payment card account to which a purchase transaction is to be charged. In the case of other types of POS location, the payment card account number is input into the POS location by human data entry or the like. The card may be a conventional magnetic stripe card or a so-called contactless (RFID) payment card or other payment device. (Thus, the “card”, as it has been referred to herein, need not be in a card-shaped form factor.)

Each of the POS locations 102 shown in FIG. 1 is connected to a merchant computer 104. (In cases where more than one merchant participates in the system 100, there may be more than one merchant computer included in the system, although only one is shown in the drawing.) Each POS location 102 uploads to the merchant computer 104 transaction data that represents purchase transactions performed at the POS location. In some embodiments, the POS locations 102 only upload to the merchant computer 102 transaction data for transactions in which payment cards were used. Moreover, in some embodiments, the transaction data uploaded by the POS locations may include only transactions in which the merchant's co-branded payment cards were used.

The transaction data may be uploaded from the POS locations 102 to the merchant computer 104 directly or indirectly (e.g., via an intervening computer or computers, not shown). In some embodiments, data for all payment card transactions is uploaded to the merchant computer 104 (or intervening computer) and the merchant computer 104 (or intervening computer) sorts out for storage and further processing only transactions that utilized the merchant's co-branded cards. (Although not shown in FIG. 1, the system may also include conventional acquirer computers (not shown) and/or card transaction processor computers (not shown) that handle payment system authorization requests initiated by the POS locations for the payment card transactions. The term “acquirer” is widely used in the payment processing field, and refers to financial institutions such as banks or other financial systems that have agreements with merchants to receive and forward purchase transaction authorizations and settlement requests on behalf of the merchants. The term “acquirer” also refers to processing agents that act on behalf of such financial institutions or systems. Each acquirer typically serves numerous merchants.)

In some embodiments, the transaction data includes purchased item data that identifies the particular product items purchased in each transaction. For example, items purchased may be identified by SKU (stock-keeping unit) number and/or by UPC (Universal Product Code) number.

The transaction data also includes the payment card account number that identifies the payment card account to which the respective transaction is being charged. The transaction data may include additional information, such as the date and time at which the transactions occurred. Still other data may be included, such as the store department or location (e.g., aisle or floor) for each product item included in the transactions.

In a typical embodiment, all of the transaction data stored and transmitted by the merchant computer 104 relates only to transactions that were performed at the merchant's retail store locations. That is, the transaction data from the merchant computer 104 does not represent any transaction other than transactions performed at the merchant.

The merchant computer 104 aggregates the transaction data into batches. For example, the merchant computer 104 may aggregate each day's transaction data into a batch of data which the merchant computer uploads at the end of the day to a rebate computer 106 that is also part of the system 100. The merchant computer 104 may alternatively upload the transaction data to the rebate computer at regular intervals (e.g., weekly) other than daily, or at irregular intervals. Details of the rebate computer 106 will be provided below.

In some embodiments, the transaction data only includes transactions performed with the merchant's co-branded payment cards. In other embodiments, the transaction data includes transactions using other or all payment cards. In some embodiments, the transactions represented by the transaction data were all performed with payment cards of a certain association brand (e.g., only MasterCard-branded payment cards) but are not limited to transactions that used the merchant's co-branded payment cards.

The system 100 also includes a payment system 108. The payment system 108 may, in terms of its internal operations, operate in a substantially conventional manner. The payment system 108 may, for example, be the very well-known system managed by MasterCard International Inc., which is the assignee hereof. Thus, the payment system 108 may include, for example, one or more payment processing systems such as the Banknet system and the Global Clearing Management System (GCMS), and also may include computers operated by numerous issuers (issuing financial institutions) which issue payment card accounts. As is well known, the payment processing systems operate to route transactions to the issuer computers and to clear funds through the system. As will be seen, the payment system 108 may handle “payment transactions” initiated by the rebate computer 106 to implement customer rebates in accordance with aspects of the present invention. (As is familiar to those who are skilled in the art, a “payment transaction” is a transaction in a payment card system that—in contradistinction to a purchase transaction—results in a flow of funds to an issuer of a payment card account and from the issuer as a credit to the cardholder's account. Thus, a payment transaction runs in the reverse direction relative to a purchase transaction, with the latter resulting in a charge to, and withdrawal of funds from, the cardholder's account.)

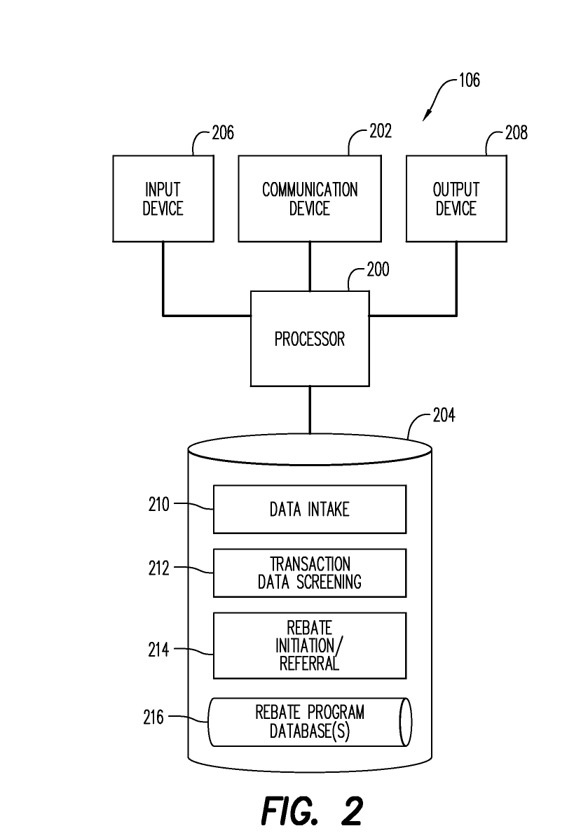

FIG. 2 is a simplified block diagram of the rebate computer 106 that is shown in FIG. 1. The rebate computer 106 may be conventional in its hardware aspects but may be controlled by software to cause it to operate in accordance with aspects of the present invention.

The rebate computer 106 may include a computer processor 200 operatively coupled to a communication device 202, a storage device 204, an input device 206 and an output device 208.

The computer processor 200 may be constituted by one or more conventional processors. Processor 200 operates to execute processor-executable steps, contained in program instructions described below, so as to control the rebate computer 106 to provide desired functionality.

Communication device 202 may be used to facilitate communication with, for example, other devices (such as the merchant computer 104 and one or more computers that are part of the payment system 108).

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium.

Storage device 204 stores one or more programs for controlling processor 200. The programs comprise program instructions (which may be referred to as computer readable program code means) that contain processor-executable process steps of rebate computer 106, including, in some cases, process steps that constitute processes provided in accordance with principles of the present invention, as described in more detail below.

The programs may include an application 210 that allows the rebate computer 106 to receive and store batches of transaction data transmitted from the merchant computer 104. This transaction data may be as described hereinabove in connection with the merchant computer 104. In addition the programs may include an application 212 that controls the rebate computer 106 to screen the transaction data for the purpose of identifying purchase transactions (and/or individual purchased items included in the transactions) that qualify the cardholder/customer for rebates pursuant to rebate programs administered by the rebate computer 106.

Application 214 is another application that may be included in the programs stored in the storage device 204. Application 214 may include software program instructions to control the rebate computer 106 to initiate payment transactions in the payment system 106 to cause rebates to be credited to the payment card accounts of cardholders determined by the rebate computer 106 as qualifying for rebates.

Storage device 204 may also store one or more databases 216 that contain data related to operation of the rebate program or programs. For example, the databases 216 may include (a) a database which stores rules for identifying qualified transactions/transaction items and/or amounts of rebates in connection with one or more rebate programs administered by the rebate computer 106; (b) transaction data uploaded from the merchant computer 104 and awaiting or currently undergoing screening; and (c) data that reflects results of screening the transaction data, including data that represents payment transactions to be initiated in the payment system 108 to implement the rebates for qualified purchases/purchased items as well as underlying purchase transaction data upon which the rebates are based. All of this data may be referenced, used, screened and/or generated by the application 212 in the course of controlling the rebate computer 106 to identify transactions/transaction items that have qualified for rebates.

In some embodiments, the rebate computer 106 software may include reporting applications so that the rebate computer 106 can provide reports of rebate program activity and results. The reports may be provided, for example, to merchants and/or to product manufacturers/distributors who sponsor the rebate programs.

There may also be stored in storage device 204 other unshown elements that may be necessary for operation of the rebate computer 106, such as an operating system, a database management system, other applications, other data files, etc.

The other computers referred to above in connection with FIG. 1 may be conventional in terms of their hardware aspects and thus may be similar in hardware architecture to the rebate computer 106.

In some embodiments, the rebate computer 106 may be operated by the payment card association (e.g., the assignee hereof) which manages the payment system 108, or by an affiliate of the payment card association. In other embodiments, the rebate computer 106 may be operated by a service provider that is independent of the payment card association and the merchant. In still other embodiments, the rebate computer 106 may be operated by the merchant itself, and may even be integrated with the merchant computer 104. In some embodiments, the system 100 may include more than one rebate computer 106, operated by different entities.

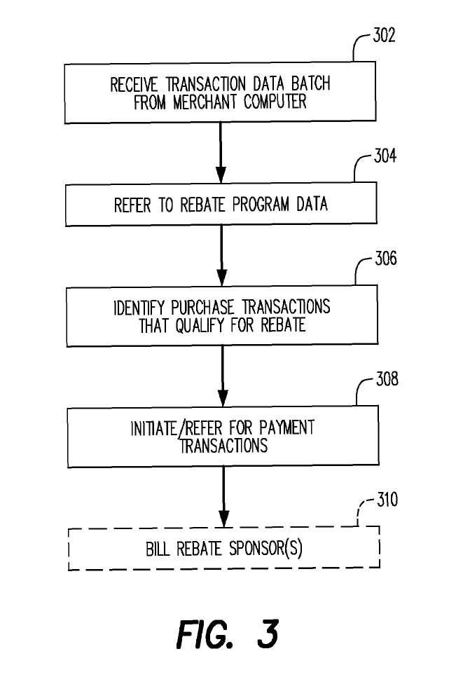

FIG. 3 is a flow chart that illustrates a process performed in accordance with aspects of the present invention in the rebate computer 106.

At 302 in FIG. 3, the rebate computer 106 receives a batch of transaction data (as described above) that has been transmitted from the merchant computer 104. In some embodiments the batch of transaction data may be received in the form of a flat file. Presumably, the batch of transaction data includes only purchase transactions that the merchant computer 104 has not previously uploaded for screening to the rebate computer 106. (However, in some embodiments, the rebate computer 106 may engage in a process step—which is not indicated—in which the rebate computer 106 confirms that the received batch of transaction data does not duplicate, or partially duplicate, transaction data that has previously been uploaded from the merchant computer 104.)

At 304 in FIG. 3, the rebate computer 106 refers to data (stored in one or more of the databases 216, FIG. 2) that defines various rebates programs administered by the rebate computer 106. The rebate programs may take any one of a number of different forms. For example, in a simple form of a rebate program, if a given product (e.g., identified by a certain UPC number) is purchased during a given time period, then the purchaser is qualified to receive a rebate in a specified amount.

According to a somewhat more complicated type of rebate program, a “buy one get one free” offer or a “buy one get one half off” offer may be implemented by a rebate program. For the former, if two items of the specified product were bought in a single transaction, then the purchase qualifies to receive a rebate equal to the purchase price of one of the items. Similarly, for the latter type of offer, the purchase of the two identical qualifying items in the same transaction qualifies the purchaser to receive a rebate equal to half of the purchase price of one of the items.

Some types of rebate programs, on the other hand, may require the system to track a customer's purchases over a period of time. For example, a rebate program may call for a rebate to be provided for every fifth 2-liter bottle of a certain type of soda that the customer buys from the merchant during each calendar month. For the purpose of such a program, the rebate computer 106 may store data reflecting how many bottles of that soda the customer has purchased during the current month. For every fifth such bottle, the customer is found to qualify for a rebate equal to the price of the bottle of soda.

Other types of rebate programs may support cross-selling promotions. For example, a beer company and a snack food company may cooperate to offer a rebate for a purchase of a certain category of snack food package in conjunction with a six-pack of beer. When the required type of beer six-pack and the required type of snack food item are purchased in one transaction, the customer qualifies for a rebate (say a third of the price of the snack food) funded jointly by the beer company and the snack food company.

In another type of cross-selling promotion that may be implemented in this system, the customer may earn a rebate by purchasing a first item from one merchant and then a second item from a different merchant. It can be assumed for purposes of this example that both merchants participate in the system (i.e., both upload transaction data to the rebate computer 106). To aid in implementing this type of promotion, it may be necessary for the rebate computer to keep records of at least some of the customers' potentially qualifying purchases. To make explicit what is probably already understood, in this type of promotion, the rebate computer initiates (or produces data that leads to initiation of) a payment transaction to the customer based on the customer satisfying a rebate condition, where the rebate condition is purchasing one item at one merchant and another item at another merchant, where the two items are different from each other and the two merchants are different from each other. A similar promotion could call for making purchases at two different stores operated by the same merchant. The respective items purchased at the two stores may or may not be different from each other.

Still other types of rebate programs may be sponsored by the merchant itself to drive traffic to particular parts of the merchant's stores. For example, a pharmacy merchant may offer a rebate that implements a “50 cents off” offer on shampoo when the customer purchases shampoo in the same transaction with a pharmacy prescription. This may help drive traffic to the hair care aisles of the merchant's stores.

According to other types of rebate programs, the merchant (possibly in cooperation with product manufacturers/distributors) may in effect engage in “congestion pricing” to give customers incentives to visit the merchant's stores at particular times of day/days of the week. For that purpose, the rules for a particular rebate program may prescribe a time of day period during which a particular product item must be purchased to qualify for the rebate.

The rebate system disclosed herein may also be employed to implement a sweepstakes type of promotion. For example, all customers who buy a certain item at a merchant (or group of merchants) during a given time period may be entered in a drawing, with the prize(s) in the drawing being in cash that is remitted to the winner(s) via payment transaction(s) in the payment system 108. With this type of system, it may become economical to offer a relatively large number of small cash prizes. The cost of printing, handling and securing “game tokens” or the like would be eliminated with this type of program.

In still another type of promotion that may be implemented in the system 100, customers may be allowed to opt for having their rebates directed to one or more charitable organizations. The remittance of the resulting contributions may be via payment transactions into special accounts for the charitable organizations, where the accounts are accessible via the payment system 108.

Based on the disclosure herein, those who are skilled in the art will recognize that many other types of rebate programs may be implemented with the system 100. The rebate computer 106 may administer many rebate programs at a given time.

At 306 in FIG. 3, the rebate computer 106 uses the stored rebate program rule or rules to consider each purchase transaction and/or each purchased item reflected in the batch of data to determine whether the purchase transaction/purchased item qualifies the customer for a rebate.

To implement the rebates for purchase transactions/purchased items identified at step 306 as qualifying by the rebate computer 106, the rebate computer 106 may (as indicated at 308 in FIG. 3) generate payment transactions in the payment system 108 to credit the rebates to the payment card accounts of the customers who qualified for the rebates. With respect to each rebate, the request for the payment transaction may specify the amount to be credited and the payment card account number for the payment card account of the customer who is to receive the rebate. In some embodiments, a separate payment transaction may be initiated for each rebate. In other embodiments, at least some rebates due to a particular customer from a particular transaction data batch or batches may be aggregated into a single payment transaction.

In some embodiments, the payment transactions may be funded from a special rebate account that is established with a financial institution retained by the entity that operates the rebate computer 106 and/or that administers the rebate program(s). The special rebate account may have an account number that allows it to be properly identified in the requests for payment transactions initiated by the rebate computer 106.

In addition or alternatively, the rebate computer 106 may not itself initiate the payment transactions, but instead may generate a file of rebate data containing the information necessary for requesting the payment transactions, and may upload the rebate data to another entity (e.g., the payment card association) which in turn may initiate the payment transactions needed to implement the rebates.

In the event that the customer returns a purchased item so as to get credit for the item, the return transaction may be included in the transaction data uploaded by the merchant computer 104. The rebate computer may detect the return transaction and may submit a suitable transaction request to the payment system 108 so as to reverse an earlier payment transaction which implemented the rebate for the original purchase of the item.

In step 310 in FIG. 3, the rebate computer 106 may submit billing files to one or more rebate sponsors (e.g., product manufacturers/distributors and/or merchants) to obtain reimbursement for the rebates identified and implemented by the rebate computer 106.

In some embodiments, it may be desirable for purposes of risk management to require the rebate sponsor to prefund the rebate payments according to the expected redemption rate. The rebate payment prefunding may be held in a special account from which the payment (rebate) transactions in the payment system are funded.

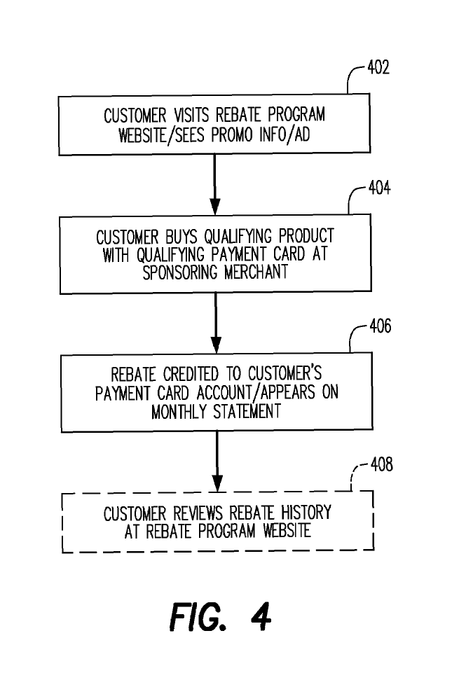

FIG. 4 is a flow chart that illustrates aspects of a rebate program process from the point of view of a customer/cardholder.

At 402 in FIG. 4, a customer who holds a qualifying payment card account becomes aware of a particular rebate offer. This may occur, for example, when the customer visits a rebate program website to view a listing of currently available rebate offers. Such a website may, for example, be hosted by a computer operated by the merchant, the product manufacturer distributor, or an entity that manages one or more rebate programs and/or operates the rebate computer 106. Alternatively, the customer may become aware of a rebate offer via a direct mail promotional piece or advertising circular, or via a broadcast media commercial, or via an ad displayed on a website not affiliated with the rebate system. Still another possibility is that the customer may learn of the rebate offer via a display in the merchant's retail store.

At 404 in FIG. 4, the customer purchases a qualifying product item with his/her payment card and in a transaction that complies with the rules for the rebate offer. Next, at 406, the system 100 detects the qualifying purchase and credits the rebate to the customer's payment card account in the manner described above with respect to FIG. 3. In some embodiments, the credit may appear on the customer's monthly payment card account statement with the explanation, “rebate” or “(retailer's name) rebate program”. In some embodiments, the customer may be allowed to visit a web-based member account page associated with his/her payment card account to view (as per step 408 in FIG. 4) the details of the rebate that was credited to his/her payment card account. In some embodiments, several rebates may be credited to the payment card account in a given month, and in at least some cases a single rebate line item on the account statement may reflect two or more different rebates that were combined into a single payment transaction for crediting to the customer's payment card account. For example, the information on the member account page may provide details as to each rebate credited to the customer, including underlying purchased item(s), and date and location of purchase. The member account page may also provide information about ongoing or future rebate programs that the customer may wish to take advantage of.

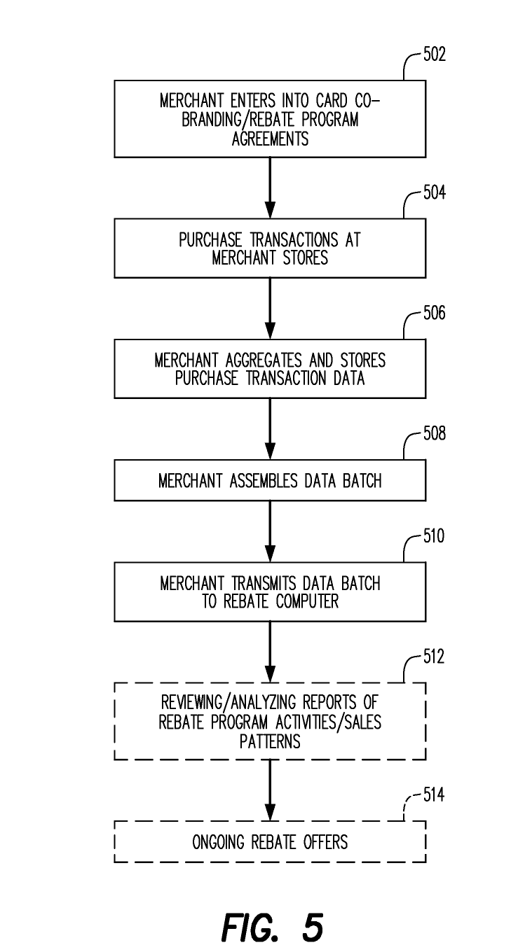

FIG. 5 is a flow chart that illustrates aspects of a rebate program process from the point of view of a merchant/retailer.

At 502 in FIG. 5, the merchant (which may for example be a major chain of retail stores in the grocery, pharmacy and/or discount department store sectors) may enter into a number of implementing agreements. For example, the merchant may enter into a co-branding agreement with a financial institution to issue association branded (e.g., MasterCard) payment cards (e.g., prepaid cards) which bear the merchant's logo, along with the financial institution's logo and the association brand. These cards may be the vehicle for one or more rebate programs and also, optionally, for the merchant's customer loyalty program as well.

One or more of the merchant, the financial institution and the payment card association may enter into agreements with product manufacturers/distributors to sponsor one or more rebate programs. For example, in some rebate programs, purchases of certain products with the merchant co-branded card at the merchant's stores may qualify for rebates funded by the manufacturer/distributor of the products. Additional qualifying conditions may also apply (such as time of day and/or purchase of another product or a minimum number of items of the product). The rebates themselves may be implemented in the manner described above with reference to FIGS. 1-3. Generally speaking, under the rebate program agreements the manufacturer/distributor and/or the merchant may also have obligations to promote the rebate offer in various ways. In some embodiments the merchant may also contribute to the funding of the rebates. In some embodiments, the co-branded payment card may also function as the cardholder's identification card for purposes of the merchant's customer loyalty program. In other embodiments, the rebate programs are supplemental to the merchant's loyalty program.

At 504 in FIG. 5, customers of the merchant make purchases that qualify for the rebate program at the merchant's stores. At 506, the merchant collects and stores the transaction data that reflects, e.g., all purchase transactions made using the merchant's co-branded payment cards. At 508, the merchant assembles a batch of the transaction data (e.g., overnight after each shopping day). At 510, the merchant transmits the batch of transaction data to the rebate computer 106, for processing as described above in connection with FIG. 3.

At 512, the merchant reviews and analyzes reports concerning the utilization and/or effectiveness of the rebate programs. Some reports may be generated directly by the merchant itself. Others may be provided by the rebate computer 106, and may summarize, for example, how many qualifying transactions occurred, as well as when and where, and how much was paid in rebates. In some embodiments, the reports may include demographic information as to the customers who qualified for rebates under the programs or statistics concerning how much the customers spent with the merchant.

Block 514 in FIG. 5 represents additional rebate offers that are developed over time on an ongoing basis by product manufacturers/distributors and/or the merchant and/or the financial institution or the payment card association. These offers also may be administered in the same manner described above in connection with FIGS. 1-3.

Like the system disclosed in the above-referenced '940 published patent application, the rebate system described herein may realize significant efficiencies by piggy-backing on an existing payment card system to deliver payment of product rebates. The system disclosed herein may also be highly flexible in terms of the types of qualification rules that may be defined for a rebate offer, without requiring any reprogramming at the POS level. Rebate programs as described herein may supplement or replace conventional merchant loyalty programs, and at least in some embodiments may do so at minimal cost to the merchant, inasmuch as the product manufacturers/distributors may fund a large part or all of the rebates.

The above-described embodiment involving a merchant co-branded payment card may in some cases be particularly advantageous for the merchant, especially in cases where the merchant is able to negotiate a reduced interchange (bank/transaction fee) rate for payment card system purchase transactions that involve the co-branded payment cards.

If the merchant co-branded card is used as a loyalty program card as well as a payment account card, its use may streamline transactions at the point of sale, in that the customer only needs to present, and the POS terminal only needs to read, one identification card rather than two.

Also, with the system as described herein, there is no requirement to include product-item level detail in the payment card system authorization or clearing messages, so that the format of those messages need not be changed to allow product-item-level rebates to be implemented via the payment card system.

In some embodiments, the batch of transaction data transmitted from the merchant computer 104 may represent purchase transactions such that some of the transactions used payment cards issued under one association brand (e.g., MasterCard) while other transactions used payment cards issued under another association brand (e.g., Visa). The rebate computer 106 may administer rebate programs that are applicable to purchase transactions using either or both types of association-branded payment cards. The rebate computer 106 may be operative to identify qualifying transactions/purchased items involving either type of association-branded card. The rebate computer 106 may be further operative to initiate payment transactions, and/or to generate rebate data files for another computer to initiate payment transactions, in two or more different payment systems that correspond to the different association brands. Thus, the system 100 depicted in FIG. 1 may include two or more payment systems to which the rebate computer is connected (at least from time to time) rather than just the single payment system 108 shown in the drawing.

As used herein and in the amended claims, the term “purchased item” or the like should be understood to refer to services available for purchase as well as physical articles that are available for purchase.

As used herein and in the appended claims, the term “time of day” refers to one or more the time of day, the day of the week, the day of the month, the month of the year, and any combination thereof.

Although the above descriptions have set forth a certain order in which the process steps are performed, this should not be understood to mandate a particular order of performing the process steps. Rather, the process steps may be performed in any order that is practicable.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a batch of transaction data transmitted from a computer operated by or on behalf of a merchant; the transaction data relating to a plurality of purchase transactions performed at the merchant, the transaction data including purchased item data that identifies at least some items purchased in the purchase transactions, the transaction data including for each purchase transaction a respective payment card account number that identifies a respective payment card account to which said each purchase transaction was charged; and
identifying, from the received transaction data, ones of said purchase transactions that qualify for customer rebates.

2. The method of claim 1, further comprising:
transmitting, to a payment system computer, a batch of rebate data, said rebate data representing rebates to be implemented by payment transactions to be initiated in a payment processing network, said payment transactions to be routed to ones of said payment card accounts identified by said rebate data.

3. The method of claim 1, further comprising:
initiating payment transactions in a payment processing network in regard to the identified purchase transactions, the payment transactions for crediting customer rebates to payment card accounts of customers who initiated the identified purchase transactions.

4. The method of claim 1, wherein said identifying step includes applying at least one rebate qualification rule to said batch of transaction data.

5. The method of claim 4, wherein:
the transaction data includes, for each of said purchase transactions, respective time data that identifies a time of day at which said each purchase transaction occurred; and
the at least one rebate qualification rule prescribes a time of day period during which a purchase transaction must have occurred to qualify for a customer rebate.

6. The method of claim 5, wherein said identifying step is performed remotely from point of sale locations at which said purchase transactions occurred.

7. The method of claim 6, wherein said identifying step is performed at least one hour after at least some of the purchase transactions occurred.

8. The method of claim 1, further comprising:
billing sponsors of said customer rebates for reimbursement relative to said customer rebates.

9. The method of claim 1, wherein said batch of transaction data represents transactions submitted by the merchant for authorization prior to the computer transmitting the batch of transaction data.

10. The method of claim 9, wherein the batch of transaction data does not represent any transactions other than transactions performed at the merchant.

11. The method of claim 1, wherein the batch of transaction data represents:
a first plurality of purchase transactions charged to payment card accounts issued under a first association brand; and
a second plurality of purchase transactions charged to payment card accounts issued under a second association brand, said second association brand different from said first association brand.

12. The method of claim 1, wherein said batch of transaction data represents exclusively transactions charged to payment card accounts issued under the merchant's brand.

13. An apparatus, comprising:
a processor; and
a memory in communication with the processor and storing program instructions, the processor operative with the program instructions to:
receive a batch of transaction data transmitted from a computer operated by or on behalf of a merchant; the transaction data relating to a plurality of purchase transactions performed at the merchant, the transaction data including purchased item data that identifies at least some items purchased in the purchase transactions, the transaction data including for each purchase transaction a respective payment card account number that identifies a respective payment card account to which said each purchase transaction was charged; and
identify, from the received transaction data, ones of said purchase transactions that qualify for customer rebates.

14. The apparatus of claim 13, wherein the processor is further operative with the program instructions to:
transmit, to a payment system computer, a batch of rebate data, said rebate data representing rebates to be implemented by payment transactions to be initiated in a payment processing network, said payment transactions to be routed to ones of said payment card accounts identified by said rebate data.

15. The apparatus of claim 13, wherein the processor is further operative with the program instructions to:
initiate payment transactions in a payment processing network in regard to the identified purchase transactions, the payment transactions for crediting customer rebates to payment card accounts of customers who initiated the identified purchase transactions.

16. The apparatus of claim 13, wherein said identifying step includes applying at least one rebate qualification rule to said batch of transaction data.

17. The apparatus of claim 16, wherein:
the transaction data includes, for each of said purchase transactions, respective time data that identifies a time of day at which said each purchase transaction occurred; and
the at least one rebate qualification rule prescribes a time of day period during which a purchase transaction must have occurred to qualify for a customer rebate.

18. The apparatus of claim 13, wherein the processor is further operative with the program instructions to:
bill sponsors of said customer rebates for reimbursement relative to said customer rebates.

19. An article of manufacture comprising:
a computer usable medium having computer readable program code means embodied therein for generating rebate data, the computer readable program code means in said article of manufacture comprising:
computer readable program code means for receiving a batch of transaction data transmitted from a computer operated by or on behalf of a merchant; the transaction data relating to a plurality of purchase transactions performed at the merchant, the transaction data including purchased item data that identifies at least some items purchased in the purchase transactions, the transaction data including for each purchase transaction a respective payment card account number that identifies a respective payment card account to which said each purchase transaction was charged; and
computer readable program code means for identifying, from the received transaction data, ones of said purchase transactions that qualify for customer rebates.

20. The article of manufacture of claim 19, wherein the computer readable program code means in said article of manufacture further comprises:
computer readable program code means for transmitting, to a payment system computer, a batch of rebate data, said rebate data representing rebates to be implemented by payment transactions to be initiated in a payment processing network, said payment transactions to be routed to ones of said payment card accounts identified by said rebate data.

21. The article of manufacture of claim 19, wherein the computer readable program code means in said article of manufacture further comprises:
computer readable program code means for initiating payment transactions in a payment processing network in regard to the identified purchase transactions, the payment transactions for crediting customer rebates to payment card accounts of customers who initiated the identified purchase transactions.

22. The article of manufacture of claim 19, wherein said identifying step includes applying at least one rebate qualification rule to said batch of transaction data.

23. The article of manufacture of claim 22, wherein:
the transaction data includes, for each of said purchase transactions, respective time data that identifies a time of day at which said each purchase transaction occurred; and
the at least one rebate qualification rule prescribes a time of day period during which a purchase transaction must have occurred to qualify for a customer rebate.

24. The article of manufacture of claim 19, wherein the computer readable program code means in said article of manufacture further comprises:
computer readable program code means for billing sponsors of said customer rebates for reimbursement relative to said customer rebates.
